(19) United States
(12) Patent Application Publication
(10) Pub. No.: US 2015/0122652 A1
(43) Pub. Date: May 7, 2015

(54) NANOCOMPOSITE POLYMER HYDROGEL WITH ALIGNED NANOPARTICLES

(71) Applicants: Jeffrey W. Thompson, Cookeville, TN (US); Holly Stretz, Cookeville, TN (US); Pedro E. Arce, Cookeville, TN (US)

(72) Inventors: Jeffrey W. Thompson, Cookeville, TN (US); Holly Stretz, Cookeville, TN (US); Pedro E. Arce, Cookeville, TN (US)

(73) Assignee: Tennessee Technological University, Cookeville, TN (US)

(21) Appl. No.: 14/353,988

(22) PCT Filed: Jul. 19, 2012
(86) PCT No.: PCT/US2012/047380

§ 371 Date: Dec. 30, 2014

Related U.S. Application Data
(60) Provisional application No. 61/572,631, filed on Jul. 19, 2011.

(51) Int. Cl. G01N 27/447; B01D 57/02

(52) U.S. Cl. CPC G01N 27/44747; B01D 57/02
USPC 204/470; 204/469

(57) ABSTRACT

Nanocomposite polymeric hydrogels comprising polyacrylamide (PAAm) formulated in combination with magnetically-susceptible anisotropic microparticles are described, as are method of making and using said hydrogels.

### CROSS-REFERENCE TO RELATED APPLICATIONS

This patent application claims the benefit of U.S. Provisional Patent Application No. 61/572,631, filed under 35 U.S.C. §111(b) on Jul. 19, 2011, and which is hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND

1. Field

The present disclosure relates to polyacrylamide hydrogels containing magnetically or electrically aligned nanoparticles, and methods of making and using the same.

2. Description of Related Art

Nanocomposite hydrogels have received recent attention in the literature in terms of mechanical property enhancements. Nanocomposite hydrogels typically consist of a polyamide formed in water and a nanoparticle such as silica (1), clay (2-6), or gold (7). The array of property enhancements may include increased modulus (8), greater strength at break and elongation (4), variations in water uptake (1), and changes in electronic properties (7), as recently reviewed by Simhadri et. al (9). Hydrogels, in general, are commonly used media for the electrophoretic separation of charged particles such as DNA or proteins in clinical diagnostic applications. Nanocomposite-type hydrogels offer a number of advantages in electrophoretic applications over non-modified hydrogels. Current sodium dodecyl sulfate polyacrylamide gel electrophoresis (SDS-PAGE) hydrogels typically have very poor mechanical properties (8), poor shelf life, poor reproducibility of pore structure during polymerization, and poor resolution (i.e., they cannot separate or “resolve” certain molecular species because—for example—they migrate together during electrophoresis).

Nanocomposite hydrogels may offer a competitive advantage over standard hydrogel technology because of all of these properties, but little is currently understood about how incorporation of nanoparticles into the hydrogel will affect the ultimate properties in the application of protein separation. A good dispersion of nanopartides may eventually lead to nanochannels in the hydrogel, and single nanochannels are known to produce unique effects on biomolecular separations/transport (10). Therefore, it is possible that unique electrophoretic separation properties could exist for this new class of materials, which may be thought of as arrays of single nanochannels.

Matos and coworkers showed that the inclusion of isotropic silica nanoparticles incorporated into polyacrylamide (PAAm) hydrogels may alter the electrokinetic hydrodnamic mixture properties within the system (11). Additionally, Yu et al. showed that spherical gold nanoparticles may play a role in the separation of acidic and basic proteins in capillary electrophoresis (12). The clay platelet nanoparticles described herein, however, were inherently anisotropic, whereas the silica and gold in the previous case were isotropic nanoparticles. Anisotropy can uniquely affect the electrophoretic mobilities of proteins, as was recently reported by Thompson et al. for the case of gold nanorod composite hydrogels (13). Even when gold nanorods were randomly oriented in a PAAm hydrogel, a drastic change in the electrophoretic mobility of ovum serum albumin (OSA) was reported at volume fractions of less than 1% (v/v).

For clay-nanoparticle-based hydrogels, some reports exist demonstrating selective DNA-type separations. Liang et al. dispersed montmorillonite (MMT) into a low molecular weight linear polyamide-based hydrogel (14). The enhancement of DNA separation was attributed to an increased effective crosslink density due to the adsorption of polyamide chains on MMT platelets. Huang et al. explored the effect of introducing multiwalled carbon nanotubes (MWCNT) into a native gel matrix (15). Their study showed a change in separation, although the changes could be attributed to interactions either with the nanotubes or with the surfactant coating the nanotubes. Recent experimental work has shown that anisotropic morphology for a single nanochannel plays a role in separation using nanofluidic devices (16). Therefore, an anisotropic nanophase morphology may produce a change in the electrokinetic properties of the system and, in addition, unique biomolecular separations.

Nevertheless, there remains a need for improved hydrogels capable of separating biological molecules (i.e., separating different molecular species), including proteins and nucleic acids (e.g., DNA and RNA), and cells. The solution to this technical problem is provided by the embodiments characterized in the claims.

### BRIEF SUMMARY OF THE INVENTION

Nanocomposite polymeric hydrogels represent a new tool for improved separations in clinical diagnostics and therapeutics delivery among other biotechnological applications. However, the relationship between nanocomposite hydrogel structure (morphology) and mass transport (transport of proteins specifically) has not been systematically described. Described herein are polyacrylamide (PAAm) nanocomposites formulated in combination with sodium Montmorillonite (MMT) and magnetically-aligned nano-platelets, to form nanocomposite hydrogels. The nanocomposite hydrogel morphologies are characterized herein using transmission electron microscopy (TEM), wide-angle X-ray diffraction (WAXD), small-angle neutron scattering (SANS), small-angle X-ray scattering (SAXS) and cryogenic scanning electron microscopy (cryo-SEM). Electrophoresis using the hydrogels was performed under a low applied electric field of 6.7 V/cm. Morphology of the hydrogel cell structure was modified by application of an external 2 Tesla magnetic field during crosslinking. This magnetic process significantly improved electrophoretic separations. This is the first disclosure of a nanocomposite hydrogel—a hydrogel comprising magnetized (i.e., magnetically aligned) anisotropic nanoparticles—producing improved protein separations. As the anisotropic particles can be aligned magnetically, they can also be aligned electrically. Applicant believes, without wishing to be bound by theory, that the improved separation achieved with such hydrogels is caused by additional sieving associated with larger number of cells encountered on the protein's path as well as at least two electrostatic contributions: affinity, due to the charged nature of the nanoparticle, and electro-osmosis.

The present disclosure describes the effects of the addition of well-dispersed, anisotropic MMT platelets to a native PAM gel on the electrophoretic separation of proteins. The anisotropic nanoparticles were subjected to a strong magnetic field before and/or during the crosslinking of the system in an attempt to orient the platelets. Sodium MMT was selected for this study because of its susceptibility to a magnetic field in the 1-3 T range (17, incorporated by reference herein), the well-characterized high aspect ratio (18, incorporated by reference herein), and high areal charge density. Particle dispersion was characterized with transmission electron microscopy (TEM) and X-ray diffraction. The structure of the composite hydrogel was characterized with cryogenic scanning electron microscopy (cryo-SEM), TEM, small-angle X-ray scattering (SAXS), and small-angle neutron scattering (SANS).

In one embodiment, the disclosure provides a hydrogel comprising polyacrylamide and anisotropic nanoparticles wherein said nanoparticles are aligned. Said nanoparticles may be aligned by an applied magnetic field of at least about 0.5 Tesla, or by an applied AC electric field of between about 50 and about 400 Hz and between about 0.1 and about 10 kV/cm, or by an applied DC electric field of between about 0.1 and about 10 kV/cm. Said nanoparticles may be magnetized by an applied magnetic field of from about 1 to about 3 Tesla. Said nanoparticles may be selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof. Said nanoparticles may be exfoliated montmorillonite nanoparticles. Said nanoparticles may have a mean particle thickness of from about 0.8 to about 50 nm. Said nanoparticles may have a mean particle thickness of from about 1 to about 1.5 nm. Said nanoparticles may have a mean aspect ratio of from about 20 to about 500. Said nanoparticles may have a mean aspect ratio of from about 155 to about 165. Said hydrogel may have a transverse-to-parallel direction of anisotropy. Said hydrogel may have anisotropy between about 1.24 and about 2.58. Said hydrogel may have a Lorentzian intensity factor (I_{L}) between about 531 and 1460). Said hydrogel may have a short-range density (ξ) of less than 2.3. Said hydrogel may have a Debye-Bueche intensity factor (I_{DB}) of less than 45,000. Said hydrogel may have a long-range density (Ξ) of less than 15.2. Said hydrogel may have between 0.0002 and 0.0024 volume percent (with respect to polymer and water) anisotropic nanoparticles.

In one embodiment, the disclosure provides a method for preparing a hydrogel, comprising: a) mixing acrylamide, anisotropic nanoparticles, and a crosslinking agent; and b) applying either a magnetic field or an electric field to said mixture. Said magnetic field may be at least about 0.5 Tesla, and said electric field may be either an applied AC electric field of between about 50 and about 400 Hz and between about 0.1 and about 10 kV/cm, or an applied DC electric field of between about 0.1 and about 10 kV/cm. Said magnetic field may be from about 1 to about 3 Tesla. Said nanoparticles may be selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof. Said nanoparticles may be exfoliated montmorillonite nanoparticles. Said nanoparticles may have a mean particle thickness of from about 0.8 to about 50 nm. Said nanoparticles may have a mean particle thickness of from about 1 to about 1.5 nm. Said nanoparticles may have a mean aspect ratio of from about 20 to about 500. Said nanoparticles may have a mean aspect ratio of from about 155 to about 165. Said hydrogel may have a transverse-to-parallel direction of anisotropy. Said hydrogel may have anisotropy between about 1.24 and about 2.58. Said hydrogel may have a Lorentzian intensity factor (I_{L}) between about 531 and 1460. Said hydrogel may have a short-range density (ξ) of less than 2.3. Said hydrogel may have a Debye-Bueche intensity factor (I_{DB}) of less than 45,000. Said hydrogel may have a long-range density (Ξ) of less than 15.2. Said hydrogel may have between 0.0002 and 0.0024 volume percent (with respect to polymer and water) anisotropic nanoparticles.

In one embodiment, the disclosure provides a method of separating at least two different charged molecular species, comprising a) loading said at least two different charged molecular species into a hydrogel, said hydrogel comprising polyacrylamide and anisotropic nanoparticles, and wherein said nanoparticles are aligned; and b) applying an electric field to said at least two different charged molecular species and said hydrogel for a time sufficient to separate said at least two different charged molecular species. Said nanoparticles may be aligned by an applied magnetic field of at least about 0.5 Tesla, or by an applied AC electric field of between about 50 and about 400 Hz and between about 0.1 and about 10 kV/cm, or by an applied DC electric field of between about 0.1 and about 10 kV/cm. Said nanoparticles may be aligned by an applied magnetic field of from about 1 to about 3 Tesla. Said nanoparticles may be selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof. Said nanoparticles may be exfoliated montmorillonite nanoparticles. Said nanoparticles may have a mean particle thickness of from about 0.8 to about 50 nm. Said nanoparticles may have a mean particle thickness of from about 1 to about 1.5 nm. Said nanoparticles may have a mean aspect ratio of from about 20 to about 500. Said nanoparticles may have a mean aspect ratio of from about 155 to about 165. Said hydrogel may have a transverse-to-parallel direction of anisotropy. Said hydrogel may have anisotropy between about 1.24 and about 2.58. Said hydrogel may have a Lorentzian intensity factor (I_{L}) between about 531 and 1460. Said hydrogel may have a short-range density (ξ) of less than 2.3. Said hydrogel may have a Debye-Bueche intensity factor (I_{DB}) of less than 45,000. Said hydrogel may have a long-range density (Ξ) of less than 15.2. Said hydrogel may have between 0.0002 and 0.0024 volume percent (with respect to polymer and water) anisotropic nanoparticles.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIG. 1 shows a schematic defining the faces of the composite hydrogel sample, where the frame of reference for convenience is with respect to the gravity vector at the moment when electrophoresis is performed. The applied field caused the proteins to move along the direction of the gravity vector.

FIG. 2 is a TEM photomicrograph of a random MMT-based hydrogel which was polymerized onto a carbon-coated TEM grid (φ_{MMT}=0.22%).

FIG. 3 provides XRD results of polyacrylamide nanocomposite hydrogels. Note that no peaks are present throughout the 2θ scan range, consistent with exfoliation of the MMT.

FIG. 4 shows representative photomicrographs (using cryo-SEM) of transverse-face fracture surfaces for (a,b) control gel, (c,d) magnetized-filled gel, and (e,f) random gel. A histogram resulting from digital image analysis of the cell diameter is presented next to each corresponding image. The larger features indicate “cells” and the holes in the walls of the cells indicate “pores”. All of the scale bars represent 5 μm (φ_{MMT}=0.22%).

FIG. 5 shows representative photomicrographs (with cryo-SEM) of parallel-face fracture surfaces for (a,b) control gel, (c,d) magnetized-filled gel, and (e,f) random gel. A histogram resulting from digital image analysis of the cell diameter is presented next to each corresponding image. The larger features indicate “cells” and the holes in the walls of the cells indicate “pores”. All of the scale bars represent 500 nm (φ_{MMT}=0.22%).

FIG. 6 shows representative photomicrographs (with cryo-SEM) of the parallel-face fracture surfaces for the (a) control gel (scale bar=5 μm) and (b) magnetized-filled gel (scale bar=4 μm). The holes in the walls of the cells indicate the pores. These parallel-face images are not all in the same scale as in FIG. 1 (φ_{MMT}=0.22%).

FIG. 7 is a TEM image of a PAAm/MMT hydrogel (random hydrogel). The MMT platelets bent around the individual cells in the hydrogel but did not completely enclose any one cell. The cell walls cannot be seen in these images because they were composed of carbon-based polymer and do not scatter the beam as effectively as the alumino-silicate MMT did (φ_{MMT}=0.22%).

FIG. 8 shows small angle scattering of polyacrylamide nanocomposite hydrogels is random gel in SAXS, is random gel in SANS, and is magnetized gel in SAXS.

FIG. 9 shows I values from the SAXS measurements (symbols) for the control PAAm hydrogel, filled (“random”) hydrogel, and magnetized-filled hydrogel. The solid curves are the theoretical fits based on the model described herein. The data points and theoretical curve for the filled and magnetized-filled hydrogels were shifted up by factors of 2 and 10, respectively, for clarity (φ_{MMT}=0.22%) for the filled and magnetized-filled samples.

FIG. 10 is a Kratky plot for control PAAm gel. The linear fit has a correlation coefficient (R²) of 0.916.

FIG. 11 is a Kratky plot for filled PAAm/MMT. The linear fit has a correlation coefficient (R²) of 0.917.

FIG. 12 is a Kratky plot for magnetized-filled PAAm/MMT gel. The linear fit has a correlation coefficient (R²) of 0.964.

FIG. 13 shows I values from the SANS measurements (symbols) for the control PAAm and filled hydrogels. The solid curves are the theoretical fits based on the model described in the text (φ_{MMT}=0.22%) for the filled and magnetized-filled samples.

FIG. 14 shows electrophoretic mobilities μ versus mobility in the control hydrogel μ₀ measured in the nanocomposite filled (“random”) gels for the two proteins OSA and CA. φ is the volume percent montmorillonite (MMT) in the composite.

FIG. 15 shows electrophoretic mobilities μ versus mobility in the control hydrogel μ₀ measured in the nanocomposite magnetized-filled gels for the two proteins OSA and CA. φ is the volume percent montmorillonite (MMT) in the composite.

FIG. 16 is an overlay of intensity versus distance for carbonic anhydrase (far right peak) and ovum serum albumin (middle peak) after electrophoresis through magnetized-filled hydrogel of PAAm/MMT, φ=2.25×10⁻⁴. The reproducibility of the result is evident.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The subject disclosure features, in one aspect, polyacrylamide nanocomposite hydrogels formulated in combination with sodium montmorillonite (MMT) nanoparticles in the presence of a magnetic field or an electric field, to yield hydrogels comprising PAAm and aligned nanoparticles. This top-down nanomanufacturing approach led to unexpected and useful changes to the internal structure of the gels and, ultimately, to a dramatic improvement in the ability of the nanocomposite hydrogels to separate the two protein probes, ovum serum albumin and carbonic anhydrase. These proteins could not be separated with control hydrogels. The morphology of the nanocomposite hydrogel was analyzed with cryogenic scanning and transmission electron microscopy, wide-angle X-ray diffraction, and small-angle scattering to determine whether morphological changes would correlate with this improved separation. As the volume fractions of MMT were well under 1% (because of aqueous swelling), scattering data were dominated by the polymer structure. Significant morphological changes were noted at two length scales: 1) the hydrogel cell structure, at hundreds of nanometers, appeared to exhibit changes in the anisotropic orientation with magnetization; and 2) the polyamide structure, at tens of nanometers, exhibited decreasing pore size (small-angle X-ray scattering). The separation data correlated most closely with a reduction in pore size, but an additional contribution to separation from local electrostatic effects from the presence of charged MMT in the cell walls could not be discounted. Without wishing to be bound by theory, Applicant postulates that the change in the pore size associated with processing may have been due to the MMT presence altering the diffusion rates of the reactants during polymer formation. The method demonstrated herein could be used ultimately to separate proteins in their native state, with the potential retention of function for downstream applications, such as novel detection techniques or purification.

### Materials & Methods

Sodium MMT was obtained from Southern Clay Products, Gonzales, Tex. (Cloisite Na⁺) and had a cation exchange capacity of about 91 mequiv/100 g. This MMT was dispersed and exfoliated in water on the basis of methods described previously (18, incorporated by reference herein in its entirety). In particular, centrifugation has been shown to remove quartz contaminants and unexfoliated platelets and to result in stock MMT suspensions containing a large percentage of dispersed single platelets. After the addition of MMT to water (1.0 g/100 mL), the suspension was sonicated for 90 min, stirred for 24 h, sonicated again for 30 min, and then centrifuged at 4000 rpm for 1 h. The resulting stock suspension was characterized by dry weight analysis, dynamic light scattering (DLS), and atomic force microscopy (AFM). For every individual “particle,” one can measure the vertical dimension relative to the background at every point on each particle. The average value of the vertical dimension is the mean thickness of that particle. Based on the typical lateral dimensions (tens to hundreds of nanometers) and the median thickness of 1.20 nm, these particles were clearly platelets. The median thickness of 1.20 nm is consistent with the expected thickness of hydrated MMT platelets.

Acrylamide, N,N′-methylene bisacrylamide (Bis), ammonium persulfate (APS), tetramethylethylenediamine (TEMED), and high pressure liquid chromatography (HPLC) grade water were obtained from Fisher Scientific. Ovum serum albumin (OSA) from egg whites was obtained from Acros Organics, Suwanee, Ga. Carbonic anhydrase (CA) was obtained from MP Biomedicals. Tris-borate ethylenediaminetetraacetic acid buffer (TBE) was obtained from Ameresco. All materials were of the highest purity available and were used as received.

Besides montmorillonite, other nanoparticles that could be used include, without limitation, magnetically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof. Layered double hydroxides are commonly represented by the formula [M^{z+}₁₋ₓM³⁺ₓ (OH)₂]^{q+}(Xⁿ⁻)_{q/n}.yH₂O; where z=1, 2, or 3, M is a metal ion with valency (z) of I, II, or III (e.g., M^{z+}=Li⁺, Ca²⁺, Mg²⁺, Mn²⁺, Fe²⁺, Co²⁺, Ni²⁺, Cu²⁺, Zn²⁺, Al³⁺, Cr³⁺, Fe³⁺, V³⁺, Ga³⁺), q=x (where z=2) or q=2x−1 (where z=1 or 3), 0.1≦x≦0.5, Xⁿ⁻ represents a generic anion of charge n (e.g., Cl⁻, Br⁻, NO₃⁻, CO₃²⁻, SO₄²⁻, C₁₂H₂₅SO₄⁻ and SeO₄⁻), and y is from 0.5 to 4. Preferably, the nanoparticle is montmorillonite.

The nanoparticles may possess a mean particle thickness of from about 0.8 to about 50, from about 0.8 to about 45, from about 0.8 to about 40, from about 0.8 to about 35, from about 0.8 to about 30, from about 0.8 to about 25, from about 0.8 to about 20, from about 0.8 to about 15, from about 0.8 to about 10, from about 0.8 to about 5, from about 0.8 to about 4, from about 0.8 to about 3, from about 0.8 to about 2.5, from about 0.8 to about 2, from about 0.8 to about 1.5, from about 1 to about 1.5, and preferably from about 1.2 to about 1.3 nm.

The nanoparticles may possess a mean aspect ratio (defined as length/thickness or diameter/thickness) of from about 20 to about 500, from about 20 to about 450, from about 20 to about 400, from about 20 to about 350, from about 20 to about 300, from about 20 to about 250, from about 20 to about 200, from about 20 to about 150, from about 20 to about 100, from about 20 to about 50, from about 50 to about 500, from about 100 to about 500, from about 150 to about 500, from about 200 to about 500, from about 250 to about 500, from about 300 to about 500, from about 350 to about 500, from about 400 to about 500, from about 450 to about 500, from about 50 to about 450, from about 100 to about 400, from about 100 to about 300, from about 100 to about 200, from about 125 to about 175, from about 135 to about 165, from about 140 to about 165, from about 145 to about 165, from about 150 to about 165, from about 155 to about 165, and preferably from about 157 to about 161.

PAAm hydrogels were produced at 6% T, where % T (see Formula 1) reflects the concentration of monomer in the solution. The hydrogels were 3% C where % C (see Formula 2) describes the relationship between crosslinker and monomer concentrations (19, incorporated by reference herein in its entirety):

$$\begin{matrix}\% T = \frac{{Mass}_{acrylamide} + {Mass}_{Bis}}{{Volume}_{Solution}} \times 100 ; \frac{g}{ml} & Formula 1 \\ \% C = \frac{{Mass}_{Bis}}{{Mass}_{acrylamide} + {Mass}_{Bis}} \times 100 & Formula 2\end{matrix}$$

In this preferred embodiment, 3.5 g of acrylamide, 0.12 g of Bis, and variable amounts of MMT suspension were added to HPLC-grade water to ensure that the total volume of the gel solution was 60 mL. The MMT compositions after dilution to 60 mL for the three samples were 0.645, 0.322, and 0.065% (w/w). The MMT content could be expressed with a variety of methods, including volume percentage (φ) of MMT in the entire water-swollen sample (i.e., 0.216, 0.109, and 0.021%, respectively) and weight percentage of filler with respect to the polymer (i.e., 11, 5.4, and 1.0 phr, respectively). φ was calculated with a value of 2.83 g/cm³ for MMT density (20, incorporated by reference herein in its entirety) and Formula 3, where ρ_{MMT}, ρ_{water}, ρ_{acrylamide}, and ρ_{Bis}, are the densities of the respective components:

$$φ = \frac{{mass}_{MMT} / {ρ}_{MMT}}{\frac{{mass}_{MMT}}{{ρ}_{MMT}} + \frac{{mass}_{water}}{{ρ}_{water}} + \frac{{mass}_{acrylamide}}{{ρ}_{acrylamide}} + \frac{{mass}_{Bis}}{{ρ}_{Bis}}} \qquad Formula 3$$

This gel solution was then subjected to sonication for 4 h in a Branson 5210 sonic bath (Fisher Scientific, Suwanee Ga.). The PAAm/MMT composite hydrogels may be formed by the mixture of 10 mL of the gel solution with 50 μL of APS (10% w/w) and 10 μL of TEMED and immediately pouring of this solution into a casting apparatus. All of the samples were produced at 25° C., and they were allowed to polymerize overnight before electrophoresis.

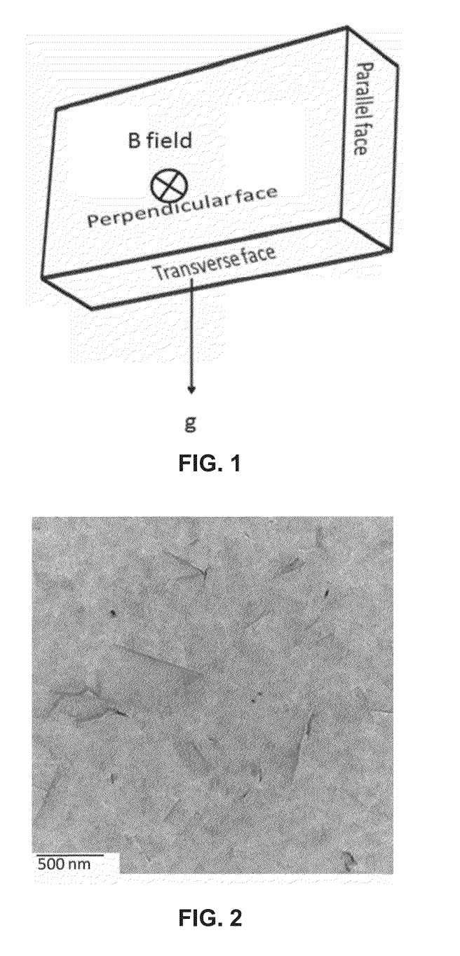

For magnetized composites, the samples were prepared by the additional step (after pouring into the casting apparatus) of quick placement of the glass container and hydrogel precursor contents into the center of a 5-in. bore magnet operated at 2.0 Tesla (Oak Ridge National Laboratory High and Thermomagnetic Superconducting Magnetic Processing Facility). The externally applied magnetic field was perpendicular to the gravitational vector, which is the frame of reference in all future descriptions of direction (see FIG. 1). Here, the gravitational vector was the direction of gravity when the vertical electrophoresis separation was performed. Thus, the gravity vector also represented the bulk direction that the proteins traveled through the composite hydrogel. The anisotropy of the casting apparatus offered a convenient method to track the magnetic orientation direction during subsequent handling/processing. The magnetic field strength was uniform (±1%) over the area in which the composite hydrogel was exposed. Samples were removed from the bore magnet after about 40 min and were observed to be solidified. At that time, it was assumed that the nanoparticles were effectively “frozen” into place and could not relax back into a random arrangement because of the constraint presented by the crosslinked gel solids around them. The samples were allowed to polymerize overnight before electrophoresis.

The magnetic field may be at least about 0.5 Tesla (T), at least about 1 T, at least about 2 T, at least about 3 T, preferably from about 1 T to about 3 T, and more preferably about 2 T. Alternatively, an externally applied electric field may be used in place of the externally applied magnetic field. Because the nanoparticles can be aligned using a magnetic field, it is also possible to align them using an electric field. The electric field may be an AC field of between about 50 and about 400, about 50 and about 300, about 50 and about 200, about 50 and about 100, about 50 and about 60, about 50, and preferably about 60 Hz and between about 0.1 and about 10, about 1 and about 10, about 2 and about 10, about 3 and about 10, about 4 and about 10, about 5 and about 10, about 6 and about 10, about 7 and about 10, about 8 and about 10, about 9 and about 10, about 7.5, and preferably about 10 kV/cm. The electric field may be a DC field of between about 0.1 and about 10, about 1 and about 10, about 2 and about 10, about 3 and about 10, about 4 and about 10, about 5 and about 10, about 6 and about 10, about 7 and about 10, about 8 and about 10, about 9 and about 10, about 7.5, and preferably about 10 kV/cm.

No postprocessing of the gels (control, filled, or magnetized), such as swelling or rinsing, was performed because such procedures could have altered the nanoparticle structure induced by the magnet.

### Transmission Electron Microscopy (TEM)

In testing of this preferred embodiment, randomly-oriented (also referred to as “filled”) PAAm/MMT samples were prepared for microscopy by the polymerization of 2 μL of a hydrogel solution onto the surface of a carbon-coated, 300-mesh Cu TEM grid. Photomicrographs were produced using a Hitachi H-7650 TEM operating at 100 kV or with a JEOL JEM-2010 instrument, Peabody, Mass. operating at 100 kV.

### Wide Angle X-Ray Diffraction (WAXD)

Wide-angle X-ray diffraction was performed on filled PAAm/MMT composite gels to obtain information about the dispersion of the days. Typically, sodium MMT shows an X-ray peak at a 2θ=6.11° (21, incorporated by reference herein in its entirety). Scans were taken on a Rigaku Ultima IV diffractometer (The Woodlands, Tex.) with Cu Kα radiation with rotation of the samples at 20 rpm. To get sufficient counting statistics, each sample was scanned for approximately 2 h.

### Small Angle X-Ray Scattering (SAXS) & Small Angle Neutron Scattering (SANS)

Small-angle scattering was employed to obtain information about the gel microstructure (e.g., pore diameters) and potential orientation of the MMT. For small angle X-ray scattering (SAXS), the samples were mounted such that the X-ray beam passed through the perpendicular face (see FIG. 1). Sample scans were taken on the previously described Rigaku Ultima IV device with a small-angle scattering attachment in transmission mode at a fixed sample angle of 1.5000°. In this mode, the detector was then scanned from 0.1° to 8.0°. The scanning speed was 0.012°/min; this led to a scan time of about 11 h for each sample to obtain sufficient counting statistics.

Small angle neutron scattering (SANS) was performed on the control and randomly oriented composite gels on a beamline BL6 extended Q-range small angle neutron scattering (EQ-SANS) at the Spallation Neutron Source, Oak Ridge National Laboratory Oak Ridge, Tenn. The incident neutron beam penetrated the perpendicular face (see FIG. 1).

### Cryogenic Scanning Electron Microscopy (Cryo-SEM)

Different samples were cut to expose two of the faces, the parallel and transverse faces, as defined in FIG. 1. Samples were then frozen by dipping the mounting/sample in liquid nitrogen (with oxygen removal before dipping, to prevent convection) then mounted to a Hitachi S-4800 field emission scanning electron microscope with a cryogenic stage attachment. After mounting, the samples were freeze-fractured with a 130, 95, 130-K temperature cycling process. Water was removed by sublimation to eliminate the possibility of surface-tension-derived artifacts associated with a traditional drying process. The representative nature of this sample preparation procedure for hydrogel morphology has been discussed elsewhere (22-27, incorporated by reference herein in their entirety). Images were also produced for the third face, the perpendicular face, but the hydrogel was too thin to be mounted in a manner consistent with the fracturing procedure described previously, and these images were not of a quality necessary for subsequent analysis. Multiple images for the other two faces (transverse and parallel) were produced in random positions and at various magnifications, and these were analyzed digitally with Adobe Photoshop to produce statistics on the feature dimensions. The features (e.g., cells) were individually measured in Photoshop along both a long and short axis, and an average of the two values was counted for analysis. Only the cells in the fracture plane were used. The number of features (n) measured are shown in TABLE 1.

TABLE 1
Digital Image Analysis Results and Hydrogel Cell Diameters

| | | | | | Ratio of the | |
|---|---|---|---|---|---|---|
| | | | Number- | Weighted- | large/small | |
| | View | | average cell | average cell | feature size | Direction of |
| Sample | orientation | n | size (nm)^{a} | size (nm)^{a} | (anisotropy) | anisotropy^{b} |
| Control | T | 315 | 477 | 526 | | |
| Control | P | 240 | 591 | 637 | 591/477 = 1.24 | P→T |
| Magnetized | T | 451 | 400 | 432 | | |
| Magnetized | P | 436 | 278 | 296 | 400/278 = 1.44 | T→P |
| Random | T | 264 | 587 | 632 | | |
| Random | P | 98 | 227 | 238 | 587/227 = 2.58 | T→P |

P, parallel;
T, transverse
^{a}The standard deviations were approximately 50-150 nm.
^{b}The directions of anisotropy are defined with respect to the FIG. 1 orientations.

Two types of averages are presented: a number average, and a weighted average. These values were calculated with the following formulae, where n, is the number of particles with average diameter dᵢ:

$$\begin{matrix}number average = \frac{{\sum }_{i} {n}_{i} {d}_{i}}{{\sum }_{i} {n}_{i}} & Formula 4 \\ weighted average = \frac{{\sum }_{i} {n}_{i} {d}_{i}^{2}}{{\sum }_{i} {n}_{i} {d}_{i}} & Formula 5\end{matrix}$$

### Electrophoretic Testing

All hydrogels were tested for electrophoretic separation characteristics. The gels were cast at 10 cm×10 cm×0.8 mm and were immersed in a trisborate ethylenediaminetetraacetic acid buffer at pH 8.0. Dansyl chloride labeled OSA and dansyl chloride labeled CA (10 μL with a 1 mg/mL concentration) were loaded into the gel lanes. Gel electrophoresis was performed at constant voltage (6.67 V/cm) for a period of 45 min with a Fisher FB1000 power supply (Fisher Scientific, Suwanee, Ga.). Note that the voltage, not the current, was specifically controlled. After electrophoresis, the gels were placed under a home-assembled UV lamp-illuminator apparatus (Porter's Camera, Cedar Rapids, Iowa) to measure the protein band position and to determine the electrophoretic velocities. For the case of the filled hydrogels, five replicates were tested. For the case of the magnetized-filled hydrogels, only two replicates were tested because of limited user time on the Oak Ridge National Laboratory magnet.

### Results

To gain valuable and useful insight in terms of the structure-property relationships, the novel composite hydrogel material morphology was characterized rigorously. This involved three types of samples. The crosslinked hydrogel control had no added nanoparticles. The nanocomposite hydrogel formed in the presence of water-dispersed sodium MMT is referred to herein as “filled,” or “random,” and the orientation of the MMT was not intentionally manipulated. The nanocomposite hydrogels formed in the presence of a uniform 2-T magnetic field are termed “magnetized,” or “magnetized-filled.” In the latter case, it was assumed that any orientation occurred faster than the polymer crosslinking process, a reasonable assumption given previous 15 reports by Koerner et al. (17, incorporated by reference herein in its entirety) on the orientation of MMT in epoxies. T (6%) and C (3%) were the same for all three types of samples. A thorough discussion of the hydrogel morphology obtained under these three processing conditions follows and, subsequently, a discussion is presented of the electrophoresis results for the two model proteins used as probes: OSA and CA. The morphology and electrophoresis are then compared.

### Example 1

### Nanoparticle Characterization

The MMT solution was characterized by both AFM and DLS according to procedures that were previously published (18, incorporated by reference herein in its entirety). AFM showed an average particle size of 201 nm, an average particle thickness of 1.3 nm, and an average aspect ratio of 159. DLS showed an effective hydrodynamic diameter of 219 nm; this was in reasonable agreement with the size from AFM. On the basis of the AFM results, about 83% of the MMT particles in the suspension were pristine single platelets, and 98% were either singlets or doublets.

About 83% of the particles seen in the AFM images had mean thicknesses between 0.9 nm and 1.5 nm: these were pristine single platelets. If one defines exfoliation as the production of pristine single platelets, one could say that this sample was 83% exfoliated. About 15% of the particles had mean thicknesses between 1.6 and 2.5 nm. Typically, these were single platelets with all or part of a second platelet on top. Even pristine single platelets are often observed to have small fragments somewhere on their top surface. If the second platelet fragment is large, it may cover most of the surface of the first platelet underneath. This can be called a “duplex” stack (two platelets). Strictly speaking, these platelets are not exfoliated. However, one can say that 98% of the MMT in this sample was exfoliated into single platelets or duplex stacks. No significant incidence of duplex stacks that appeared to be created due to the random deposition of one pristine single platelet overlapping part of another single platelet was observed.

For every individual particle in each AFM image, image analysis provided the lateral area in nm². One may compute a characteristic lateral length for a particle as the square root of the measured area. The particle's aspect ratio equals the characteristic lateral length divided by the mean thickness of that individual particle. In this way, one can measure the exact aspect ratio of every particle in an AFM image.

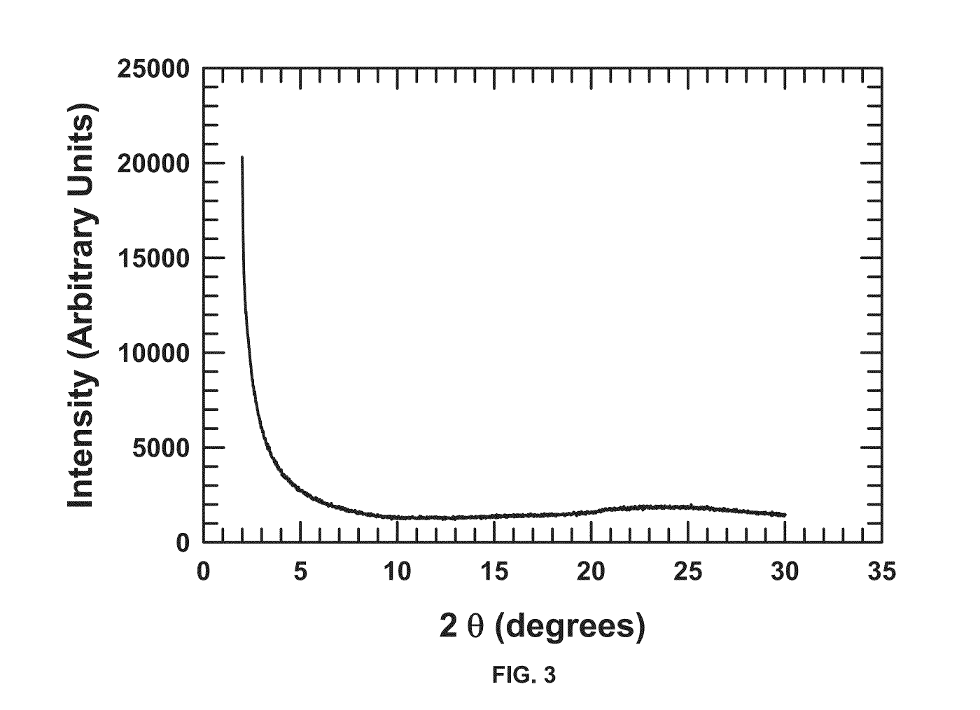

FIG. 2 presents TEM photomicrographs of the MMT particles in the filled hydrogel. The MMT particles were not as well exfoliated as the original well-characterized Na-MMT water suspension (previously discussed); however, they were still well dispersed. FIG. 3 presents representative X-ray diffraction (WAXD) information for a randomly-oriented PAM/MMT sample, and no peaks were observed. The XRD analysis is consistent with the conclusion that the MMT in the hydrogel composites continued to exhibit a high degree of exfoliation

### Example 2

### Structure of the Hydrogels

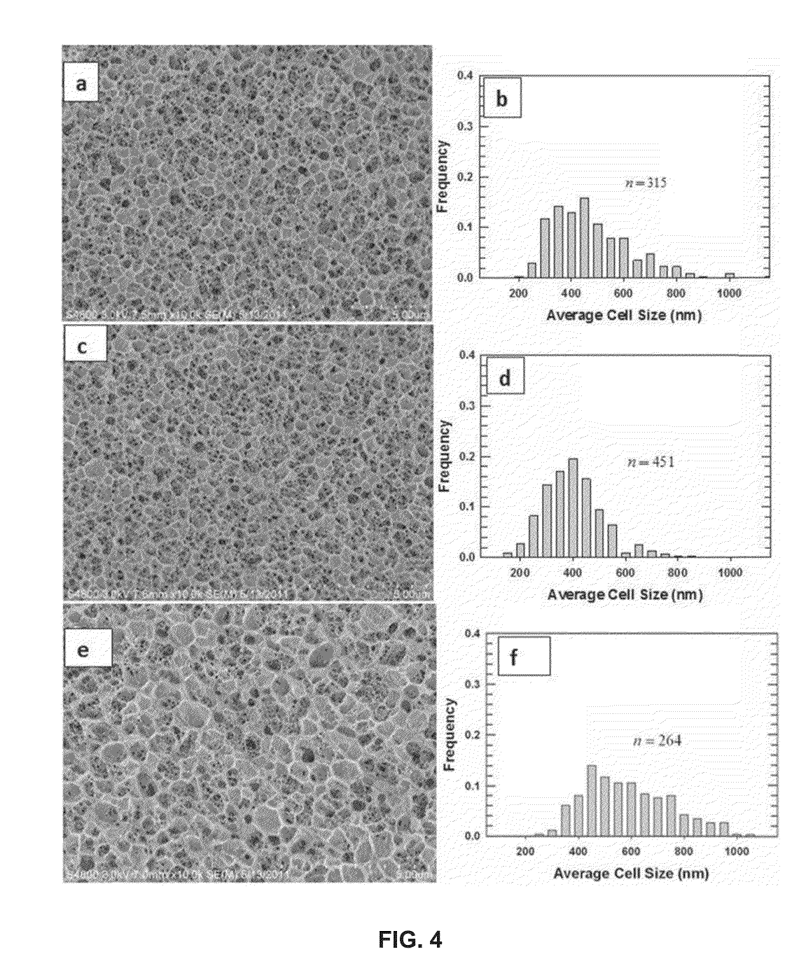

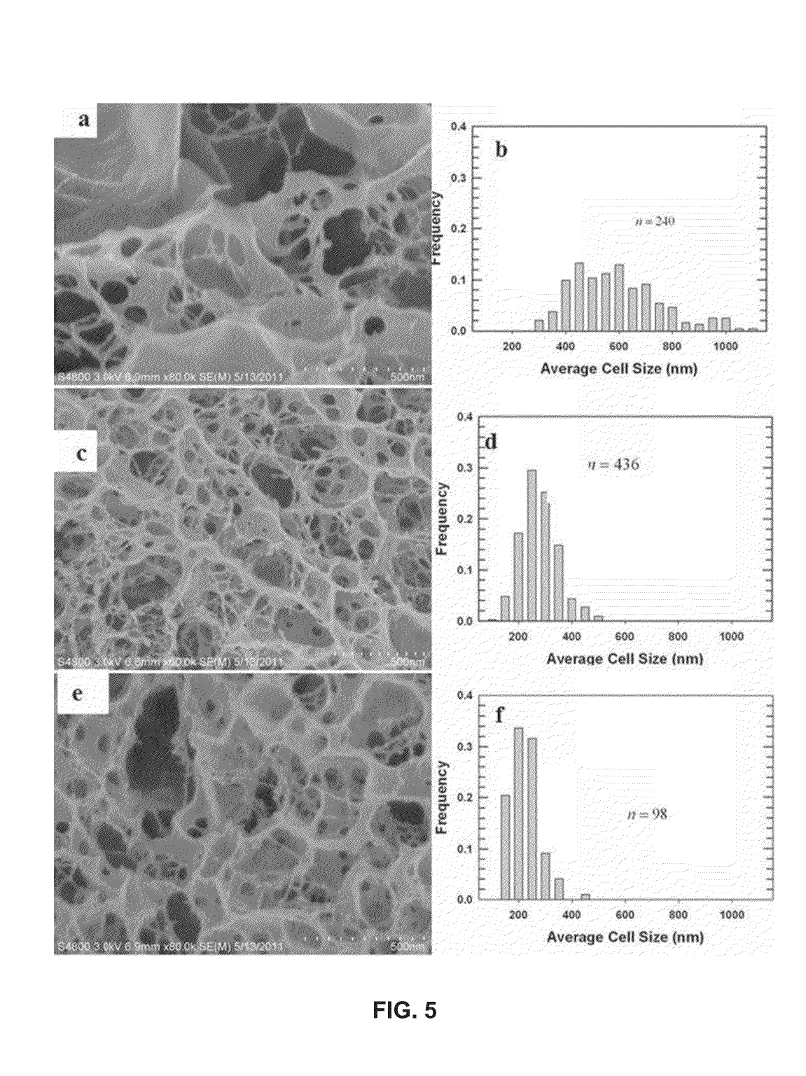

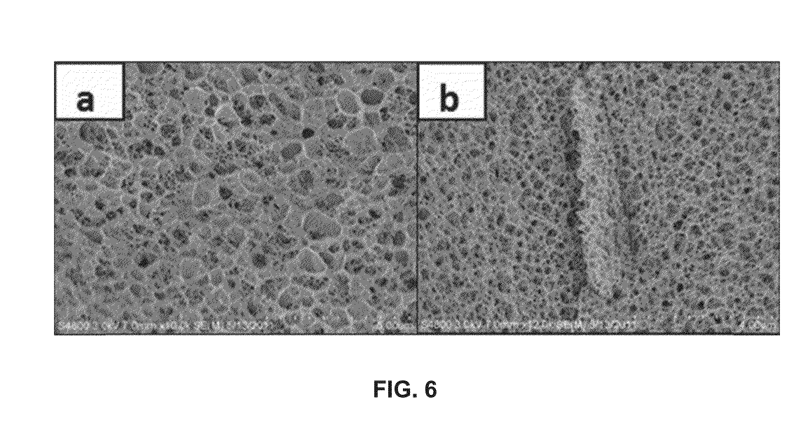

To discuss the hydrogel structure, FIG. 1 is referred to as the frame of reference for viewing the hydrogels along the various directions: a transverse face, a parallel face, and a perpendicular face. The cryo-SEM samples were prepared to produce images along these three faces with great care to preserve the submicrometer structure. In situ cryogenic techniques were used for sample handling, and the images were of a planar fractured surface. Representative photomicrographs of the transverse face of the three formulations are compared in FIG. 4. Representative photomicrographs of the parallel face of the materials are compared FIG. 5. The magnifications from FIGS. 4 and 5 do not match, so additional images are presented in FIG. 6, with a view along the parallel face to provide a more complete comparison. Corresponding histograms of the digital image analysis results are also presented in FIGS. 4 and 5 and are discussed. Statistical information about these feature dimensions is listed in TABLE 1. Although images were obtained along the perpendicular face, the fracture techniques did not produce representative features, and thus, these images are not discussed.

Qualitatively, it was initially noted when viewing FIGS. 4 and 5 that features in a single photomicrograph existed at multiple scales, and a convention needed to be adopted to describe the various features. A materials science approach is used to aid the discussion. The larger features in these images resemble the cells in polymer foams and, thus, are termed “cells.” The walls or membranes forming these cells were sometimes closed and sometimes exhibited small holes. The holes might be expected to be the most resistive element associated with the mass transport of solutes, at least in terms of molecular sieving. The holes in the walls are termed “pores.” The spaces between crosslinks, which were too small to be seen in these images, are termed “free volume.” Stellwagen (28, incorporated by reference herein in its entirety) recently published a review on the structure/property relationships in the electrophoresis of biomacromolecules that discusses the importance to mass transport of the two distinct feature sizes. Although terminology from the materials science perspective versus the electrophoresis perspective may not overlap, the presence of the two feature sizes that Stellwagen discusses certainly matches these observations (28). Another general issue to note in these scanning electron microscopy (SEM) images is the absence of any feature easily attributed to the presence of MMT nanoparticles, and this is discussed later.

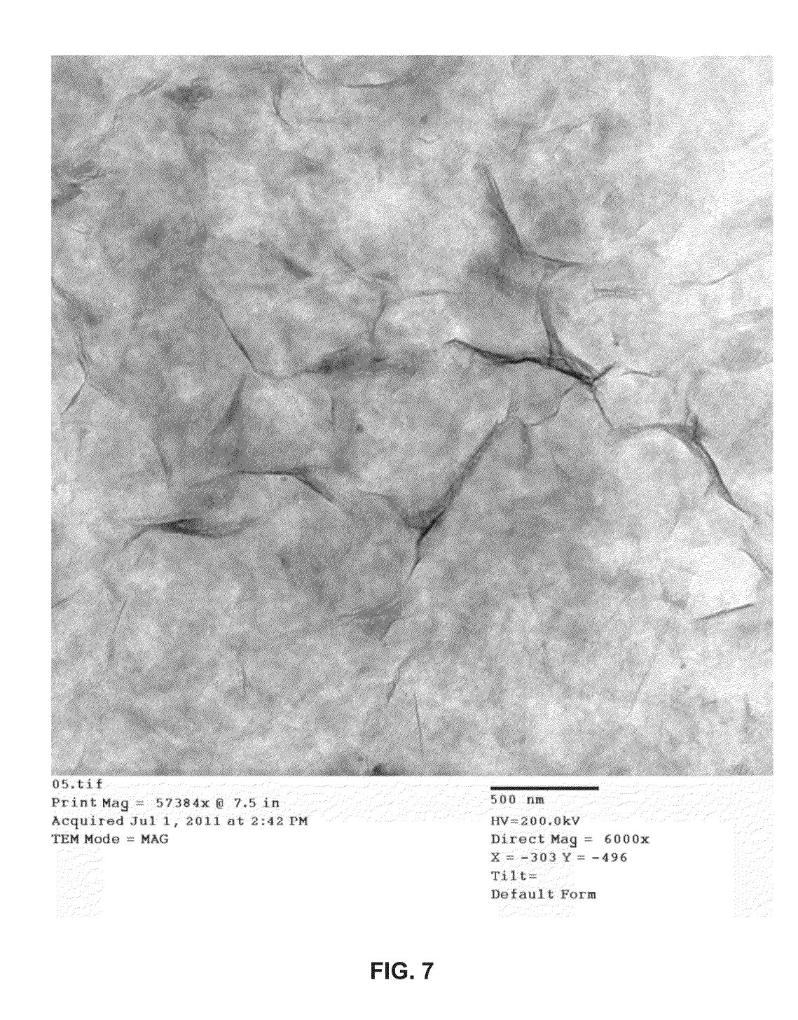

One clear observation in a comparison of the number-average cell diameters, as listed in TABLE 1, is that all of the features exhibited some anisotropy. The control PAAm hydrogel had a smaller average cell diameter when viewed along the transverse direction (477 nm) than when viewed along the parallel direction (591 nm). The ratio of these values (larger/smaller) was 1.24. Similarly, the magnetized-filled hydrogel had a smaller cell diameter of 278 nm and a larger diameter of 400 nm; this yielded an apparent anisotropy ratio of 1.44. The differences in these ratios may not have been significant, but what was very different about the two materials was the direction of this anisotropy. In the case of the control hydrogel, the largest features were seen along the parallel direction, and the opposite was true for the magnetized-filled hydrogel. One possible explanation for the anisotropy in the control was that the presence of the glass boundary affected cell formation and led to constrained cell dimensions in one direction. This result was consistent with reports by Gemeinhart et al. (29, incorporated by reference herein in its entirety) in which the type of glass used (hydrophobicity or hydrophilicity of the glass coating) influenced the hydrogel cell structure and led to pseudo-cylindrical cell geometries. In the case of the composite hydrogel cells, it was hypothesized that the MMT had, instead, templated the formation of the cells during polymerization. The MMT platelets are thought to be reinforcing agents within the cell walls in these images (FIGS. 4(c) and 5(c)), with individual platelets collecting at this interface and bending with the curvature of the cell wall, although never completely enveloping a cell. This bending or conforming at an interface has been observed by many others, including by Stretz el al. (30, incorporated by reference herein in its entirety) for multiphase poly(acrylonitrile-butadiene-styrene)/MMT nanocomposites. The MMT platelets were not distinguishable in the SEM images here because they were too thin to resolve and because they appeared white; this was hidden by the bright white edges of the cell walls. Evidence supporting the presence of MMT dispersed throughout the gel is shown in FIG. 7. This TEM photomicrograph of the composite hydrogel on a TEM grid shows the MMT platelets bending around some invisible domain (the carbon-based polymeric cell walls cannot be seen in a TEM image) but never completely enclosing the domain. Because the MMT platelets were present in the cell walls as the walls were forming, it is believed that they could affect the directionality of the forming wall. Nic et al. (31, incorporated by reference herein in its entirety) concluded, for instance, that oligomeric PAAm attaches to the MMT initially, and this reduces the mobility of growing chains, which is consistent with the MMT acting as a template for cell wall growth.

The combination of a reinforcing wall template (MMT) and orientation of the MMT in the magnetic field could have been responsible for the change in the directionality of the cells. TABLE 1 also shows that the composite hydrogels that were not exposed to a magnetic field (“Random”) exhibited the same reversed directionality of the cells when compared to the control hydrogel; however, the cells were unexpectedly larger when viewed along the transverse direction (587 nm) in this less controlled case. These larger dimensions may not be desirable during electrophoresis, as discussed later.

### Example 3

### Small Angle X-Ray Scattering and Small Angle Neutron Scattering (SAXS and SANS)

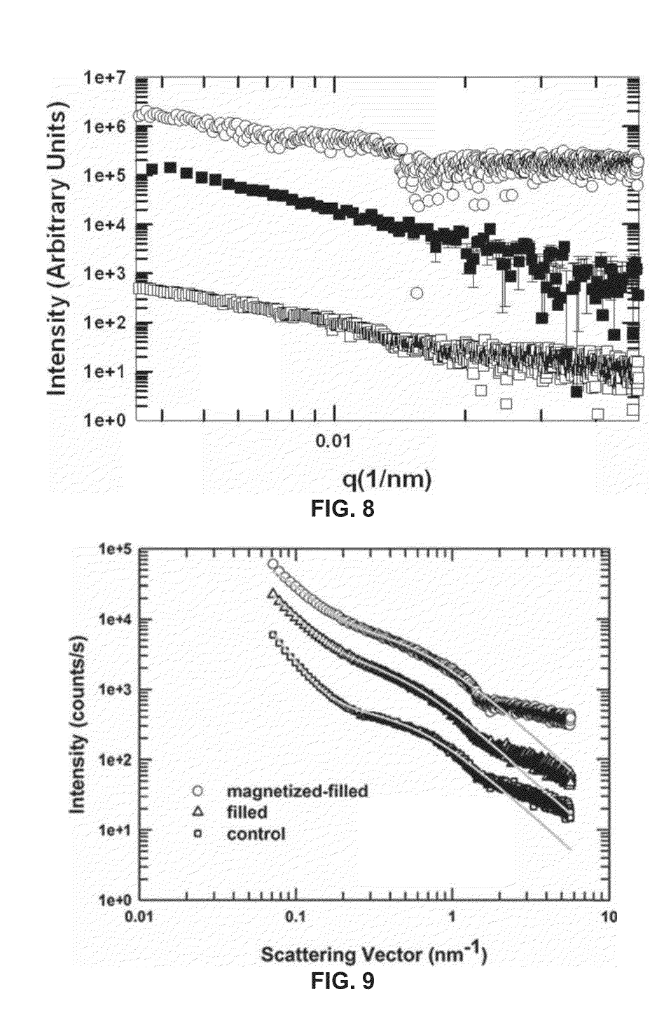

Originally, the MMT in the magnetized samples was expected to be oriented, as seen by Koerner et al., (17) for epoxy/MMT composites. Therefore, both SAXS and SANS were performed in hopes of characterizing the bulk degree of platelet orientation. Scans for SAXS and SANS are presented in FIG. 8. The samples analyzed were at the highest MMT concentration corresponding to φ=0.22% (v/v). Other ways to express this filler concentration for the same sample would be weight percent w=0.6% (w/w) or 11 phr. Each scan was normalized by the highest intensity values. Data were converted to q-space from 2θ by using Formula 3:

$$q = \frac{4 π sin ( θ )}{3 λ} \qquad Formula 3$$

Data are presented as difference plots (composite minus polymer). No apparent structural information was obtainable from the SAXS or SANS scans of either random or magnetized composite gel. This would suggest that either the concentration of the material was too low or the MMT was not aligned (in the case of the magnetized composite gel). One potential explanation for this lack of alignment involved the bending of MMT nanodiscs, as seen in FIG. 7, as they conformed with the cell wall. Thus SAXS and SANS data are consistent with the previous electron microscopy results.

### Example 4

### Data Analysis

The scattered intensity (I) as a function of the momentum transfer (q) from SAXS and SANS measurements were fit with a theoretical expression suitable for crosslinked hydrogels, including PAAm32 and other polymers (33-37, incorporated by reference herein in their entirety):

$$I ( q ) = \frac{{I}_{DB}}{( 1 + {Ξ}^{2} {q}^{2} )} + \frac{{I}_{L}}{1 + {ξ}^{2} {q}^{2}} \qquad Formula 6$$

The first term is the Debye-Bucche expression (38, incorporated by reference herein in its entirety) for scattering due to long-range density fluctuations [correlation length associated with the long-range density (Ξ)], described in terms of a two-density random medium with a sharp interface (39, incorporated by reference herein in its entirety). The second term is a Lorentzian function for scattering from semidilute polymer solutions with the correlation length associated with the short-range density (ξ). The parameter values were established in the way suggested by Koberstein et al. (38). First, with Zimm plots (I⁻¹ versus q²), linear fits of the data in the range 0.1 nm⁻²<q²<1.2 nm⁻² were used to determine values of the Lorentzian intensity factor (I_{L}) and ξ. The excess scattering (Iₑₓ) for the range q²<0.1 nm⁻² was computed as

$${I}_{ex} ( q ) = I ( q ) - \frac{{I}_{L}}{1 + {ξ}^{2} {q}^{2}} \qquad Formula 7$$

Finally, with Debye-Bueche plots (Iₑₓ^{-1/2} versus q²), linear fits of the data in the range q²<0.04 nm⁻² were used to determine values of the Debye-Bueche intensity factor (I_{DB}) and Ξ.

### Results

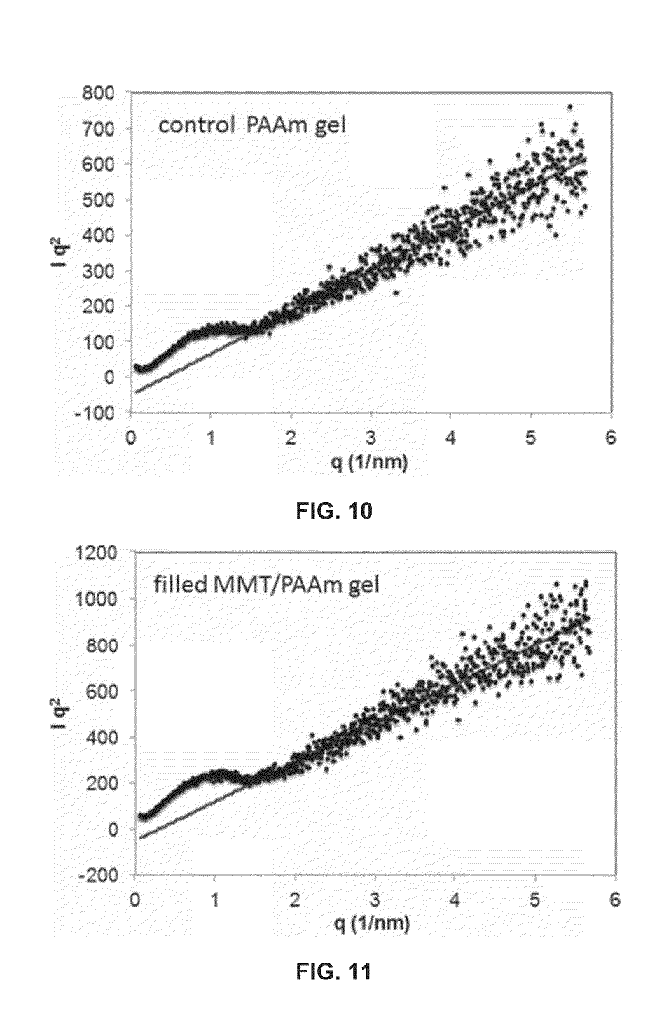

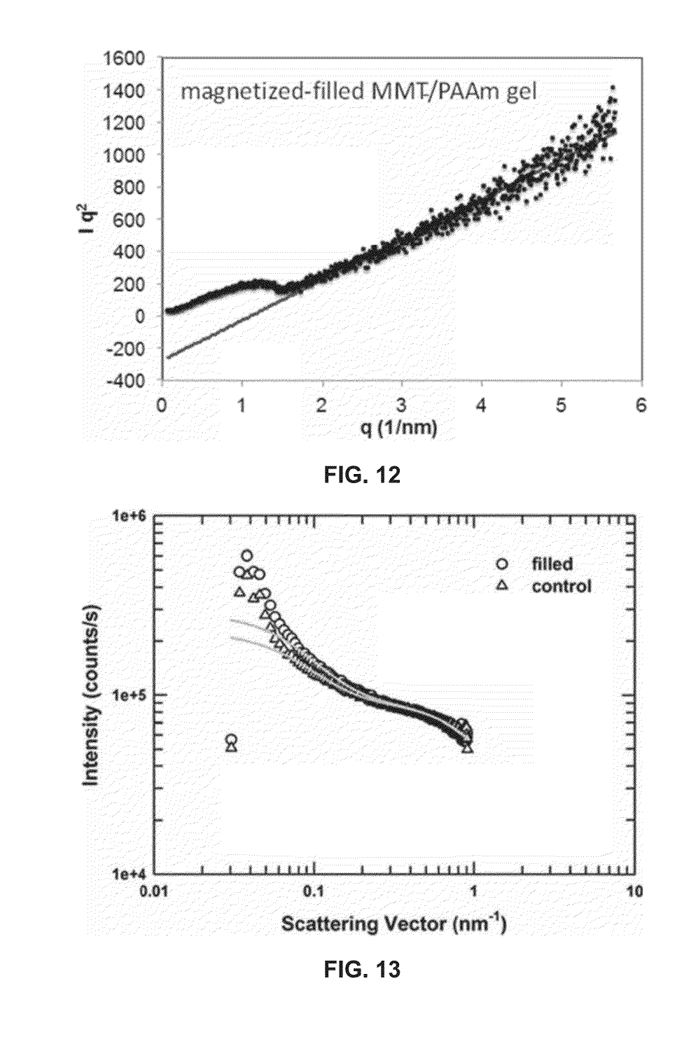

FIG. 9 shows the scattered intensity [I(q)] values for various hydrogels from the SAXS measurements. Model predictions appear overlaid here as the thin lines behind the scatter data. In general, the shapes of the I(q) curves for the PAAm/MMT hydrogels were similar to that of the control PAAm hydrogel. This suggested that scattering from the PAAm gel structure dominated in all of the samples. At larger scattering angles (q>1.5 nm⁻¹), I(q) decreased approximately as q⁻¹; this could be seen more clearly in Kratky plots [q²I(q) versus q (see FIGS. 10-12)], which were linear for q>1.5 nm⁻¹. This scattering pattern indicated a rodlike structure and is expected for polymers at length scales smaller than the chain persistence length (40, incorporated by reference herein in its entirety). The transition to I−q⁻¹ behavior occurred at about q=1.5 nm⁻¹ and corresponded to a persistence length (Lₚ⁰=1/q) of about 0.66 nm or a Kuhn (statistical segment) length of about 1.33 nm. This agreed closely with the Kuhn lengths previously reported for PAAm and which ranged from 1.0 to 1.7 nm (41-43, incorporated by reference herein in their entirety). This result, observed for the PAAm/MMT composites and the control PAAm, further supported the conclusion that the SAXS pattern primarily manifested the structure of the PAAm gel. The presence of MMT in the composites seemed to have little effect on the SAXS pattern, presumably because of its low weight loading (0.6 wt %).

TABLE 2
Model Parameters Obtained from the SAXS Data with Formula 6

| | I_{L} | ξ (nm) | I_{DB} | Ξ (nm) |
|---|---|---|---|---|
| Control hydrogel | 531 | 1.8 | 89,100 | 24.0 |
| Filled hydrogel | 1460 | 2.3 | 45,000 | 15.2 |
| Magentized-filled hydrogel | 726 | 1.8 | 9,600 | 10.4 |

For q<1.5 nm⁻¹, Formula 6 fit the scattering data well. TABLE 2 shows the parameter values. The good fit of the Lorentzian term at intermediate q values (˜0.3-1.5 nm⁻¹) indicated scattering from a semidilute polymer solution with characteristic ξ between entanglement points. The value of ξ for the PAAm gel (1.8 nm) agreed with values found in a previous study (32, incorporated by reference herein in its entirety). The value of ξ for the magnetized-filled hydrogel was similar, but that for the filled PAAm/MMT gel was higher (2.3 nm). It is not known whether this observation was significant. The Debye-Bueche term fit the SAXS data well at lower q values. The quantity Ξ represents the characteristic length scale associated with long-range density fluctuations created by crosslinks in the polymer network. The control PAAm gel had a value of Ξ of 24.0 nm, which was in reasonable agreement with that found previously (32, incorporated by reference herein in its entirety). However, a 37% smaller value of Ξ was found for the filled PAAm/MMT hydrogel (15.2 nm). For the magnetized-filled hydrogel, Ξ was 34% smaller than that of the random hydrogel and 58% smaller than the control hydrogel. These observations indicated that the presence of MMT had a discernible effect on the larger scale domain structure associated with the crosslinked PAAm network.

FIG. 13 shows I(q) for the control and filled PAAm/MMT hydrogels from SANS measurements, with model predictions based on Formula 6 overlaid as solid curves (fit parameter values given in TABLE 3). The shapes of the I(q) curves for the control and filled PAAm/MMT hydrogels were very similar. Formula 6 fit the SANS data well for q>0.07 nm⁻¹. The correlation lengths were smaller than those obtained from the SAXS data, however, and there was no difference between the control PAAm and filled PAAm/MMT gels (ξ=0.8 nm and Ξ=8.7 nm for both gels). This may have been due to the low contrast difference between the gel and H₂O in SANS, which resulted in a poorer discrimination of the gel structure than seen in the SAXS results. Also, both SANS patterns showed a peak at about q=0.04 nm⁻¹ located below the q range probed by SAXS. These peaks suggested a microstructure with a characteristic length scale of 2π/q≈150 nm. Without wishing to be bound by theory, Applicant speculates that this length scale may have been associated with the cell size observed in the cryo-SEM images. This point should be addressed in greater depth with SANS with contrast variation (via the D₂O/H₂O ratio).

TABLE 3
Model Parameters Obtained from the SANS Data with Formula 6

| | I_{L} | ξ (nm) | I_{DB} | Ξ (nm) |
|---|---|---|---|---|
| Control hydrogel | 91,600 | 0.84 | 134,000 | 8.7 |
| Filled hydrogel | 92,600 | 0.87 | 192,500 | 8.7 |

### Discussion of Characterization

At this point, one can only speculate as to the mechanism by which MMT influenced the topology of the forming crosslinked PAAm network. The presence of MMT and the process of magnetization in the pre-cured solution affected the diffusion of acrylamide and bisacrylamide during the curing process and, thus, the network topology of the gel. In the absence of platelets, the reactant diffusion was unimpeded; the bisacrylamide could react and form larger knots that were smaller in number and relatively far apart (Ξ=24.0 nm). In the presence of randomly oriented MMT platelets, bisacrylamide diffusion was hindered; this resulted in a larger number of somewhat smaller knots that were, consequently, closer together (Ξ=15.4 nm). If the magnetic field aligned the platelets during an early polymerization stage, diffusion was hindered even more, as predicted by barrier models (44-47, incorporated by reference herein in their entirety). This further increased the number of knots and reduced their size and spacing (Ξ=10.2 nm). Two aspects of this hypothesis will need to be tested. First, one may obtain direct evidence that the magnetic field aligns MMT platelets in the pre-cured acrylamide/bisacrylamide solutions; the work of Koerner el al. (17, incorporated by reference herein in its entirety) strongly suggests alignment under the conditions disclosed herein, but verification of alignment during the cure would be desirable. Second, further structural studies involving the systematic variation of bisacrylamide concentration in the presence of MMT would be helpful. The effect of the crosslinker concentration on the PAAm gel structure seems to be well understood (48-50, incorporated by reference herein in their entirety).

### Example 6

### Electrophoretic Testing

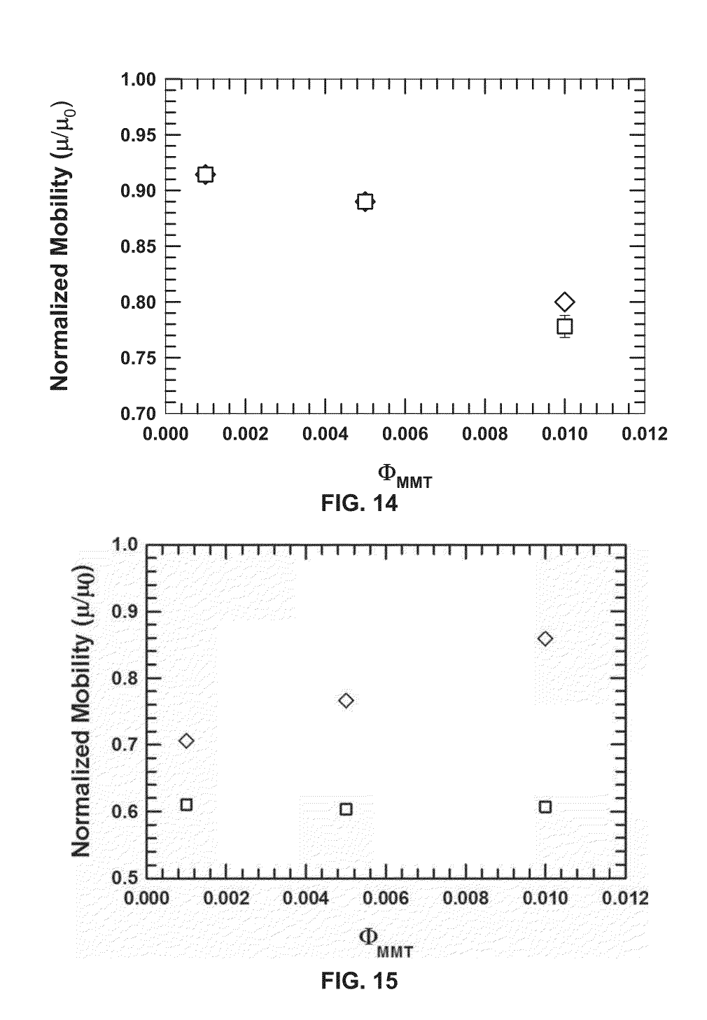

In FIG. 14, the effect of increasing the nanoparticle content (in the absence of magnetization) on the electrophoretic mobilities is presented for two proteins: CA [molecular weight (MW)=28,900, pI=5.9 (see 51)] and OSA [MW=45,000, pI=4.6 (see 52)]. Note that the mobilities presented in FIG. 14 were normalized by the corresponding mobility for the control. Increasing filler content lowered the mobility of both proteins. This result was consistent with a tortuous path effect, which Applicant's previous work demonstrated was one appropriate model for an OSA protein probe at the same electrical field moving through a composite hydrogel of PAAm/gold nanoparticles (13, incorporated by reference herein in its entirety). However, some separation of the two proteins was achieved at the highest loading of MMT nanoparticles. Producing hydrogels with greater MMT content was impractical, however, because the MMT suspension was provided at a certain concentration, and the processing of the suspension (e.g., by centrifugation) to concentrate it could have resulted in changes in the excellent dispersion of nanoparticles.

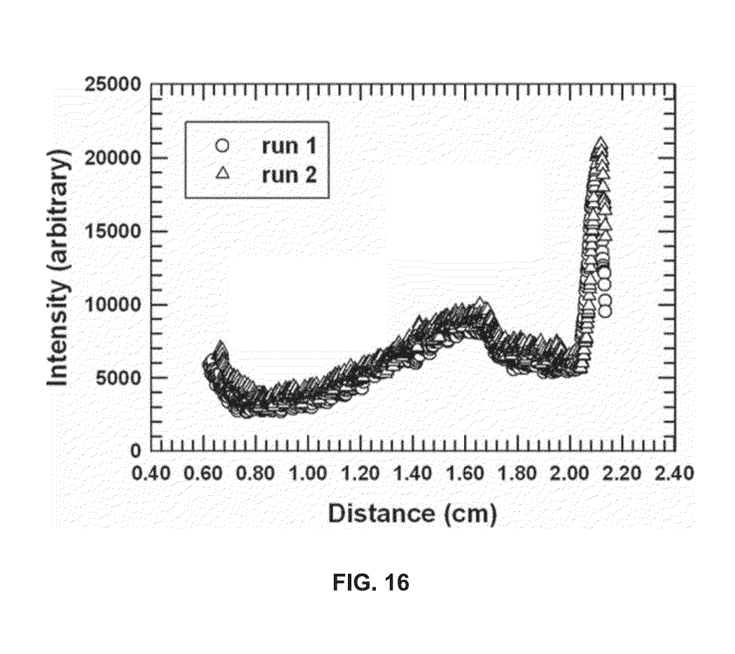

As shown in FIG. 15, magnetizing the MMT nanoparticles during gel formation led to a very different electrophoretic result. Increasing the loading of magnetized nanoparticles improved separation in all of the compositions. Note that the analysis was replicated with hydrogels magnetized at a separate time, and duplicate results were plotted but could not be resolved on this scale. See FIG. 16, for an overlay of the chromatographic-type peaks indicating excellent reproducibility. OSA and CA would be otherwise difficult to separate (they were inseparable in the control gel) because molecular sieving is not sensitive enough in general to differentiate these MWs. Something intrinsic to the addition of MMT in connection with magnetization produced a unique and unexpected separation. An important feature of this separation was that the proteins did not need to be denatured (e.g., by sodium dodecyl sulfate in standard sodium dodecyl sulfate polyacrylamide gel electrophoresis separations) to achieve separation. The proteins could retain their activity for later downstream applications such as novel detectors or purification.

In terms of the structure/property relationships, four models could be invoked to explain these data. The first was previously discussed, that is, the tortuous path effect. Here, one would have expected the protein velocity to slow down because the impermeable high-aspect-ratio MMT particles presented a tortuous path. For magnetized-filled PAAm/MMT, the proteins moved more slowly on average than they did in the filled PAAm/MMT. Both composite hydrogels had the same concentration of MMT, however. Therefore, tortuous path theory alone did not predict all aspects of protein velocity. The other three models include: (1) that cell size affected mobility, specifically that smaller cells along the direction of the protein movement caused the protein to encounter more cells; (2) that wall charge affected the mobility and that wall charge was a function of the presence of the embedded MMT; and (3) that crosslink or pore size affected the mobility and presence of MMT during gelation and led to changes in the crosslinks or pore structure. Consider that the size of the cells might have affected the mobilities. Along the cryo-SEM parallel view, the control exhibited 591 nm diameter cells, whereas the nanocomposite exhibited 278 nm diameter cells. This meant that the proteins traveled through about 50% more cells in the nanocomposite versus the control. More cells could have meant more interactions and could have led to separation. This effect should have been true for both random and magnetized nanocomposite gels, and indeed, some evidence of improved separation could be seen for both but not to the same extent. This hypothesis does not explain all of the differences observed in the composition effect nor why CA moved selectively faster than OSA. Therefore, the effect of the cell size was not seen to contribute to this particular separation. Note that the features we designated as cells, seen in cryo-SEM, were not the same features as molecular-scale crosslinks, which SAXS measured.

Consider now that the walls of the nanocomposites might have had a different charge. A consequence of increasing the number of cells encountered by the protein in the filled hydrogels would have been increased wall exposure. As the MMT particles had a surface charge density of about 91 mequiv/100 g, electrostatic contributions could have influenced separation. The OSA may have had an affinity or repulsion for a charged MMT wall. OSA would have been expected to have a higher charge density at the buffer pH=8 than CA because the pI for OSA was lower. CA traveled faster in the composite hydrogels versus OSA (as was most evident in the magnetized hydrogel), and this was consistent with more electrostatic repulsion for CA. Also, if the charged walls of the cells altered the electroosmotic flow characteristics, separation may have resulted (53, incorporated by reference herein in its entirety). In conclusion, the charged wall scenario could have explained the differences in the mobilities of CA and OSA but not why that separation was more pronounced in the magnetized-filled gels versus the filled gels.

Finally, it was considered whether the pores and crosslinks in the gels changed during polymerization. The SAXS data support this hypothesis. The Debye-Bueche characteristic length (Ξ) in TABLE 2 decreased in the following order: Control>Filled>Magnetized-filled. This order correlated with the degree of electrophoretic separation noted for CA versus OSA. In other words, the control Ξ was the largest value, and this correlated with no separation. The random Ξ was intermediate in size, and separation was barely noted, only at the highest MMT concentration. The magnetized Ξ was the smallest value, and this correlated with the most improved separation. In conclusion, the small pore/crosslink scenario could explain the differences in the mobilities of CA and OSA and could also explain why the magnetized-filled hydrogel produced better separations than the filled hydrogel.

The review by Stellwagen (28, incorporated by reference herein in its entirety) indicated that molecular sieving alone would not be expected to produce optimized separations for proteins; thus, a combination of effects was the most likely explanation for separation in this study.

### CONLCUSIONS

Anisotropic MMT nanodiscs were successfully incorporated into a PAAm matrix in two formats: the MMT particles were randomly mixed (filled) in one, and in the other, the whole system was exposed to approximately 2 T of magnetic field during polymerization (magnetized-filled hydrogel). Electrophoresis (e.g., separation of CA and OSA) led to reduced protein mobility in both the composites, but for the magnetized-filled gels good separation of the two proteins occurred for all compositions of MMT tested. For the filled gels, separation of the proteins occurred only at the highest filler concentration studied. The structures of the three hydrogels were characterized to correlate with the structure with this novel and unexpected separation. Cryo-SEM studies showed that cells for the magnetized-filled and filled gels were much smaller along the parallel direction than in the case of the control. The parallel direction was the direction in which the proteins moved during electrophoresis. In addition, SAXS and SANS data were interpreted in terms of fits to the Lorentzian and Debye-Bueche models. Ξ showed decreasing pore diameters of 24, 15, and 10 nm for the control, filled, and magnetized-filled gels, respectively. This order correlated closely with the degree of electrophoretic separation noted in the three hydrogels for the proteins. For the magnetized-filled hydrogel, Ξ was 34% smaller than that of the random hydrogel and 58% smaller than the control hydrogel. These observations indicated that the presence of MMT had a discernable effect on the larger scale domain structure associated with the crosslinked PAAm network, potentially because of diffusion constraints for the reactants during the polymerization step. Much of the improved separation was likely due to smaller pore sizes; however, local electrostatic effects caused by the charged MMT surfaces may have also contributed.

### REFERENCES

1. Ham, M. J.; Kim, Y. H. Polym Eng Sci 2008, 48, 2439.
2. Haraguchi, K.; Takehisa, T. Adv Mater 2002, 14, 1120.
3. Haraguchi, K.; Matusuda, K. Chem Mater 2005, 17, 931.
4. Haraguchi, K.; Farnsworth, R.; Ohbayashi, A.; Takehisa, T. Macromolecules 2003, 36, 5732.
5. Haraguchi, K. Macromol Symp 2007, 256, 120.
6. Haraguchi, K.; Takehisa, T.; Fan, S. Macromolecules 2002, 35, 10162.
7. Zhao, X.; Ding, X.; Deng, Z.; Zheng, Z.; Peng, Y.; Long, X. Macromol Rapid Commun 2005, 26, 1784.
8. Okay, O.; Opperman, W. Macromolecules 2007, 40, 3378.
9. Simhadri, J. J.; Stretz, H. A.; Oyanader, M.; Arce, P. E. Ind Eng Chem Res 2010, 49, 11866.
10. Pennathur, S.; Santiago, J. G. Anal Chem 2005, 77, 6782.
11. Matos, M. A.; White, L. R.; Tilton, R. D. Colloids Surf B 2008, 61, 262.
12. Yu, C.-J.; Su, C.-L.; Tseng, W.-L. Anal Chem 2006, 78, 8004.
13. Thompson, J. W.; Stretz, H. A.; Arce, P. E. Ind Eng Chem Res 2010, 49, 12104.
14. Liang, D.; Song, L.; Chen, Z.; Chu, B. Electrophoresis 2001, 22, 1997.
15. Huang, G.; Zhang, Y.; Ouyang, J.; Baeyens, W. R. G.; Delanghe, J. R. Anal Chim Acta 2006, 557, 137.
16. Fu, J.; Schoch, R. B.; Stevens, A. L.; Tannenbaum, S. R.; Jongyoon, H. Nat Nanotechnol 2007, 2, 121.
17. Koerner, H.; Hampton, E.; Dean, D.; Turgut, Z.; Drummy, L.; Mirau, P.; Vaia, R. Chem Mater 2005, 17, 1990.
18. Ploehn, H. J.; Liu, C. Ind Eng Chem Res 2006, 45, 7025.
19. Tanaka, T. From Gels to Life; University of Tokyo Press: Tokyo, 2002.
20. Fornes, T. D.; Paul, D. P. Polymer 2003, 44, 4993.
21. Hegde, R. R.; Bhat, G. S. J Appl Polym Sci 2010, 118, 3141.
22. Mallia, V. A.; Terech, P.; Weiss, R. J Phys Chem B 2011, 115, 12401.
23. Gonzalez-Meijome, J. M.; Lopez-Alemany, A.; Almeida, J. B.; Parafita, M. A. J Biomed Mater Res Part B: Appl Biomater 2005, 76, 419.
24. Apkarian, R. P.; Wright, E. R. Microsc Microanal 2005, 11, 1088.
25. Gaharwar, A. K.; Dammu, S. A.; Canter, J. M.; Wu, C.-J.; Schmidt, G. Biomacromolecules 2011, 12, 1641.
26. Jain, S.; Dyrdahl, M. H. E.; Gong, X.; Sriven, L. E.; Bates, F. S. Macromolecules 2008, 41, 3305.
27. Taribagil, R. R.; Hillmyer, M. A.; Lodge, T. P. Macromolecules 2010, 43, 5396.
28. Stellwagen, N. C. Electrophoresis 2009, 30, S188.
29. Gemeinhart, R. A.; Park, H.; Park, K. Polym Adv Technol 2000, 11, 617.
30. Stretz, H. A.; Paul, D. R.; Cassidy, P. E. Polymer 2005, 46, 3818.
31. Nie, J.; Du, B.; Oppermann, W. Macromolecules 2005, 38, 5729.
32. Benguigui, L.; Boue, F. Eur Phys J B 1999, 11, 439.
33. Horkay, F.; Burchard, W.; Geissler, E.; Hecht, A.-M. Macromolecules 1993, 26, 1296.
34. Geissler, E.; Horkay, F.; Hecht, A.-M.; Rochas, C. Polymer 1997, 38, 15.
35. Hecht, A.-M.; Geissler, E. Phys Rev E 1999, 59, 1976.
36. Sharma, J.; Aswal, V. K.; Goyal, P. S.; Bohidar, H. B. Macromolecules 2001, 34, 5215.
37. Willcox, P. J.; Howie, D. W.; Schmidt-Rohr, K.; Hoagland, D. A.; Gido, S. P.; Pudjijanto, S.; Kleiner, L. W.; Venkatraman, S. J Polym Sci Part B: Polym Phys 1999, 37, 3438.
38. Koberstein, J. T.; Picot, C.; Benoit, H. Polymer 1985, 26, 673.
39. Shibayama, M. Macromol Chem Phys 1998, 199, 1.
40. Higgins, J. S.; Benoit, H. C. Polymers and Neutron Scattering; Clarendon: Oxford, United Kingdom, 1994.
41. Walldal, C.; Akerman, B. Langmuir 1999, 15, 5237.
42. Ritacco, H.; Albouy, P.-A.; Bhattacharyya, A.; Langevin, D. Phys Chem Chem Phys 2000, 2, 5243.
43. Kulicke, W. M.; Kniewske, R.; Klein, J. Prog Polym Sci 1982, 8, 373.
44. Lape, N. K.; Nuxoll, E. E.; Cussler, E. L. J Membr Sci 2004, 236, 29.
45. Paul, D. P.; Robeson, L. M. Polymer 2008, 49, 3187.
46. Fredrickson, G. H.; Bicerano, J. J Chem Phys 1999, 10, 2182.
47. Bharadwaj, R. K. Macromolecules 2001, 34, 9189.
48. Ruchel, R.; Steere, R. L.; Erbe, E. F. J Chromatogr A 1978, 166, 563.
49. Hecht, A.-M.; Duplessix, R.; Geissler, E. Macromolecules 1985, 18, 2167.
50. Mallam, S.; Horkay, F.; Hecht, A.-M.; Geissler, E. Macromolecules 1989, 22, 3356.
51. Badjic, J. D.; Kostic, N. M. Chem Mater 1999, 11, 3671.
52. Holen, E.; Elsayed, S. Int Arch Allergy Immunol 1990, 91, 136.
53. Yu, C.-J.; Su, C.-L.; Tseng, W.-L. Anal Chem 2006, 78, 8004.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.

What is claimed is:

1. A hydrogel comprising polyacrylamide and anisotropic nanoparticles wherein said nanoparticles are aligned.

2. The hydrogel of claim 1, wherein said nanoparticles are aligned by an applied magnetic field of at least about 0.5 Tesla, or by an applied AC electric field of between about 50 and about 400 Hz and between about 0.1 and about 10 kV/cm, or by an applied DC electric field of between about 0.1 and about 10 kV/cm.

3. The hydrogel of claim 1, wherein said nanoparticles are aligned by an applied magnetic field of from about 1 to about 3 Tesla.

4. The hydrogel of claim 1, wherein said nanoparticles are selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof.

5. The hydrogel of claim 1, wherein said nanoparticles are exfoliated montmorillonite nanoparticles.

6. The hydrogel of claim 2, wherein said nanoparticles are exfoliated montmorillonite nanoparticles.

7. The hydrogel of claim 3, wherein said nanoparticles are exfoliated montmorillonite nanoparticles.

8. The hydrogel as in claim 1, wherein said nanoparticles have a mean particle thickness of from about 0.8 to about 50 nm.

9. The hydrogel as in claim 1, wherein said nanoparticles have a mean particle thickness of from about 1 to about 1.5 nm.

10. The hydrogel as in claim 1, wherein said nanoparticles have a mean aspect ratio of from about 20 to about 500.

11. The hydrogel as in claim 1, wherein said nanoparticles have a mean aspect ratio of from about 155 to about 165.

12. The hydrogel as in claim 1, having a transverse-to-parallel direction of anisotropy.

13. The hydrogel as in claim 1, having anisotropy between about 1.24 and about 2.58.

14. The hydrogel as in claim 1, having a Lorentzian intensity factor (I_{L}) between about 531 and 1460.

15. The hydrogel as in claim 1, having a short-range density (ξ) of less than 2.3.

16. The hydrogel as in claim 1, having a Debye-Bueche intensity factor (I_{DB}) of less than 45,000.

17. The hydrogel as in claim 1, having a long-range density (Ξ) of less than 15.2.

18. The hydrogel as in claim 1, having between 0.0002 and 0.0024 volume percent anisotropic nanoparticles.

19. A method for preparing a hydrogel, comprising:
a) mixing acrylamide, anisotropic nanoparticles, and a crosslinking agent; and
b) applying either a magnetic field or an electric field to said mixture.

20. The method of claim 19, wherein either a magnetic field of at least about 0.5 Tesla is applied, an AC electric field of between about 50 and about 400 Hz and between about 0.1 and about 10 kV/cm is applied, or a DC electric field of between about 0.1 and about 10 kV/cm is applied.

21. The method of claim 20, wherein said magnetic field is from about 1 to about 3 Tesla.

22. The method of claim 19, wherein said nanoparticles are selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof.

23. The method of claim 19, wherein said nanoparticles are exfoliated montmorillonite nanoparticles.

24. The method of claim 20, wherein said nanoparticles are exfoliated montmorillonite nanoparticles.

25. The method of claim 21, wherein said nanoparticles are exfoliated montmorillonite nanoparticles.

26. The method as in claim 19, wherein said nanoparticles have a mean particle thickness of from about 0.8 to about 50 nm.

27. The method as in claim 19, wherein said nanoparticles have a mean particle thickness of from about 1 to about 1.5 nm.

28. The method as in claim 19, wherein said nanoparticles have a mean aspect ratio of from about 20 to about 500.

29. The method as in claim 19, wherein said nanoparticles have a mean aspect ratio of from about 155 to about 165.

30. The method as in claim 19, wherein said hydrogel has a transverse-to-parallel direction of anisotropy.

31. The method as in claim 19, wherein said hydrogel has anisotropy between about 1.24 and about 2.58.

32. The method as in claim 19, wherein said hydrogel has a Lorentzian intensity factor (I_{L}) between about 531 and 1460.

33. The method as in claim 19, wherein said hydrogel has a short-range density (ξ) of less than 2.3.

34. The method as in claim 19, wherein said hydrogel has a Debye-Bueche intensity factor (I_{DB}) of less than 45,000.

35. The method as in claim 19, wherein said hydrogel has a long-range density (Ξ) of less than 15.2.

36. The method as in claim 19, wherein said hydrogel has between 0.0002 and 0.0024 volume percent anisotropic nanoparticles.

37. A method of separating at least two different charged molecular species, comprising:
a) loading said at least two different charged molecular species into a hydrogel, said hydrogel comprising polyacrylamide and anisotropic nanoparticles, and wherein said nanoparticles are aligned;
b) applying an electric field to said at least two different charged molecular species and said hydrogel for a time sufficient to separate said at least two different charged molecular species.

38. The method of claim 37, wherein said nanoparticles are aligned by an applied magnetic field of at least about 0.5 Tesla, or by an applied AC electric field of between about 50 and about 400 Hz and between about 0.1 and about 10 kV/cm, or by an applied DC electric field of between about 0.1 and about 10 kV/cm.

39. The method of claim 37, wherein said nanoparticles are aligned by an applied magnetic field of from about 1 to about 3 Tesla.

40. The method of claim 37, wherein said nanoparticles are selected from the group consisting of magnetically and/or electrically susceptible anisotropic smectites, phyllosilicates, clays, micas, chlorites, bentonite, antigorite, chrysolite, lizardite, halloysite, kaolinite, illite, vermiculite, talc, palygorskite, pyrophylite, biotite, muscovite, phlogopite, lepidolite, margarite, glauconite, chlorite, laponite, layered double hydroxides, iron oxide, fibrous nanoparticles, and combinations thereof.

41. The method of claim 37, wherein said nanoparticles are exfoliated montmorillonite nanoparticles.

42. The method of claim 38, wherein said nanoparticles are exfoliated montmorillonite nanoparticles.

43. The method of claim 39, wherein said nanoparticles are exfoliated montmorillonite nanoparticles.

44. The method as in claim 40, wherein said nanoparticles have a mean particle thickness of from about 0.8 to about 50 nm.

45. The method as in claim 40, wherein said nanoparticles have a mean particle thickness of from about 1 to about 1.5 nm.

46. The method as in claim 40, wherein said nanoparticles have a mean aspect ratio of from about 20 to about 500.

47. The method as in claim 40, wherein said nanoparticles have a mean aspect ratio of from about 155 to about 165.

48. The method as in claim 40, wherein said hydrogel has a transverse-to-parallel direction of anisotropy.

49. The method as in claim 40, wherein said hydrogel has anisotropy between about 1.24 and about 2.58.

50. The method as in claim 40, wherein said hydrogel has a Lorentzian intensity factor (I_{L}) between about 531 and 1460.

51. The method as in claim 40, wherein said hydrogel has a short-range density (ξ) of less than 2.3.

52. The method as in claim 40, wherein said hydrogel has a Debye-Bueche intensity factor (I_{DB}) of less than 45,000.

53. The method as in claim 40, wherein said hydrogel has a long-range density (Ξ) of less than 15.2.

54. The method as in claim 40, wherein said hydrogel has between 0.0002 and 0.0024 volume percent anisotropic nanoparticles.
